(19) United States
(12) Patent Application Publication
(10) Pub. No.: US 2023/0419663 A1
(43) Pub. Date: Dec. 28, 2023

(54) Systems and Methods for Video Genre Classification

(71) Applicant: Microsoft Technology Licensing, LLC, Redmond, WA (US)

(72) Inventors: Oron NIR, Herzliya (IL); Mattan SERRY, Herzliya (IL); Yonit HOFFMAN, Herzliya (IL); Michael BEN-HAYM, Modiin (IL); Zvi FIGOV, Modiin (IL); Eliyahu STRUGO, Jerusalem (IL); Avi NEEMAN, Tel Aviv (IL)

(73) Assignee: Microsoft Technology Licensing, LLC, Redmond, WA (US)

(21) Appl. No.: 17/809,046

(22) Filed: Jun. 27, 2022

(51) Int. Cl. G06V 20/40; G10L 25/51; G06F 16/71

(52) U.S. Cl. CPC G06V 20/41; G06V 20/46; G10L 25/51; G06F 16/71

(57) ABSTRACT

Examples of the present disclosure describe systems and methods for video genre classification. In one example implementation, video content is received. A plurality of sliding windows of the video content is sampled. The plurality of sliding windows comprises audio data and video data. The audio data is analyzed to identify a set of audio features. The video data is analyzed to identify a set of video features. The set of audio features and the set of video features is provided to a classifier. The classifier is configured to detect a genre for the video content using the set of audio features and the set of video features. The video content is indexed based on the genre.

### BACKGROUND

Videos are generated for many purposes. Videos in different genres (e.g., news, sports, social media, education) vary in multiple respects. Video recognition and understanding requires the integration of multiple artificial intelligence (AI) models to analyze and recognize events through multimodal signals in the video (e.g., speech-to-text (STT) and facial recognition), as well as higher level aspects, such as topic inferencing. However, applying such video recognition and understanding techniques to content encompassing multiple content genres is a challenge.

It is with respect to these and other general considerations that the aspects disclosed herein have been made. Also, although relatively specific problems may be discussed, it should be understood that the examples should not be limited to solving the specific problems identified in the background or elsewhere in this disclosure.

### SUMMARY

Examples of the present disclosure describe systems and methods for video genre classification. In one example implementation, video content is received. A plurality of sliding windows of the video content is sampled to identify audio data and video data. The audio data is analyzed to identify a set of audio features and the video data is analyzed to identify a set of video features. The set of audio features and the set of video features are provided to a classifier configured to detect a genre for the video content using the set of audio features and the set of video features. The video content is indexed based on the detected genre.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Additional aspects, features, and/or advantages of examples will be set forth in part in the description which follows and, in part, will be apparent from the description, or may be learned by practice of the disclosure.

### BRIEF DESCRIPTION OF THE DRAWINGS

Examples are described with reference to the following figures.

FIG. 1 illustrates an example system for video genre classification.

FIG. 2 illustrates an example computing device that implements a system for video genre classification.

FIG. 3 illustrates an example method for video genre classification.

FIG. 4 is a block diagram illustrating example physical components of an input processing unit for executing one or more aspects of the present disclosure.

FIGS. 5A and 5B are an illustration and a simplified block diagram, respectively, of an example mobile computing device for practicing aspects of the present disclosure.

FIG. 6 is a simplified block diagram of an example distributed computing system for practicing aspects of the present disclosure.

FIG. 7 illustrates an example tablet computing device for executing one or more aspects of the present disclosure.

### DETAILED DESCRIPTION

Video content in various content areas is constantly being generated for several purposes and audiences. Such content areas are referred to as genres. Video recognition and understanding are used to extract insights from video content. Examples of insights include keywords, tags, topics, person labeling, object labeling, particular events, and the like. Insights are used to enhance the search experience for users and to make content more discoverable.

Video recognition and understanding requires the integration of multiple artificial intelligence (AI) models (e.g., speech-to-text (STT) models, facial recognition models, inferencing models) to analyze and recognize events through multimodal signals in the video content (e.g., audio signals and video signals). In previous video analysis systems, each AI model available to the video analysis system is applied to each instance of video content received by the video analysis system. However, video content in different genres (e.g., news, sports, social media, education) vary in multiple respects, such as duration, information density in speech or activity, use of jargon, number of speakers, and so on. Often times, one or more of the AI models are essentially inapplicable to certain genres and, thus, do not provide insights or provide insights of minimal value. For example, surveillance models that evaluate person attributes are inapplicable to animated character recognition and audio models that evaluate audio attributes are inapplicable to soundless video content. As such, applying these inapplicable models to video content needlessly increases operational compute resource usage (e.g., central processing unit (CPU) usage, memory usage, storage usage). Applying these inapplicable models to video content also increases the number of irrelevant or minimally relevant insights generated for the video content, thereby decreasing the overall quality of the set of insights generated for the video content and negatively impacting the user experience.

In light of the above-described challenges with previous video analysis systems, the present disclosure describes systems and methods for using video genre classification to determine AI models that are relevant to the video content. In embodiments, video content is received by a video content analysis system. The video content may be comprised within a digital video file (e.g., an MP4 file, an MPEG file, a MOV file), an analog video file (e.g., a video graphics array (VGA) file or a color graphics adaptor (CGA) file), or streaming data (e.g., a set of digital signals provided by one or more sources). The video content analysis system samples a plurality of sliding windows of the video content to identify audio data and video data. The audio data is analyzed to identify a set of audio features and the video data is analyzed to identify a set of video features. The set of audio features and the set of video features are provided to a classifier configured to identify one or more genres for the video content. Based on the identified genre(s), the video content is indexed using, for example, keywords or metadata tags that are indicative of the identified genre(s).

In examples, a subset of AI models that are applicable to the indexed video content is selected from a set of AI models. For example, if the video is determined to be soundless, a set of AI models configured to evaluate soundless video content are selected, whereas AI models that are not configured to evaluate soundless video content are not selected. The subset of AI models is then used to evaluate the video content. As such, evaluating the video content using only the subset of AI models decreases the operational compute resources associated with video recognition and understanding. Further, as each of the subset of AI models is configured to evaluate the video content, the insights provided by the subset of AI models are particularly relevant to the video content. Thus, the subset of AI models enables the video content analysis system to provide more precise insights while reducing the number less relevant insights, thereby significantly enhancing the user experience.

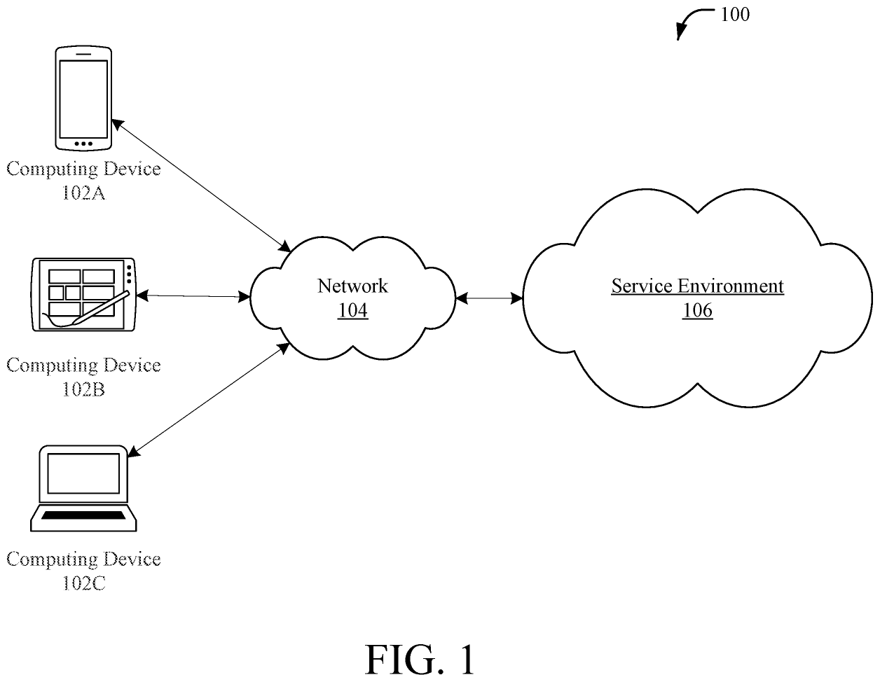

Referring now to FIG. 1, a system for video genre classification is illustrated. Example system 100 comprises computing devices 102A, 102B, and 102C (collectively “computing device(s) 102”), network 104, and service environment 106. One of skill in the art will appreciate that the scale and structure of systems such as system 100 may vary and may include additional or fewer components than those described in FIG. 1. As one example, system 100 may comprise additional networks and/or service environments. As another example, service environment 106 may be implemented in one or more of computing device(s) 102. Examples of computing device(s) 102 include personal computers (PCs), mobile devices (e.g., smartphones, tablets, laptops, personal digital assistants (PDAs)), server devices (e.g., web servers, file servers, application servers, database servers), virtual devices, wearable devices (e.g., smart watches, smart eyewear, fitness trackers, smart clothing, body-mounted devices, head-mounted displays), gaming consoles or devices, and Internet of Things (IoT) devices. Examples of network 104 include a private area network (PAN), a local area network (LAN), a wide area network (WAN), and the like. Although network 104 is depicted as a single network, it is contemplated that network 104 may represent several networks of similar or varying types. As one example, network 104 may be a LAN connecting computing device(s) 102 to a proxy device and a WAN connecting the proxy device to other one or more services or back-end devices.

Computing device(s) 102 may be configured to detect and/or collect input data from one or more users or devices. In some examples, the input data corresponds to user interaction with one or more software applications or services implemented by, or accessible to, computing device(s) 102. In other examples, the input data corresponds to automated interaction with the software applications or services, such as the automatic (e.g., non-manual) execution of scripts or sets of commands at scheduled times or in response to predetermined events. The user interaction or automated interaction may be related to the performance of an activity, such as a task, a project, or a data request. The input data may include, for example, voice input, touch input, text-based input, gesture input, video input, and/or image input. In one example, the input data is streaming data (e.g., an audio stream or a video stream). In one example, the input data may be a currently uploading data file or a previously uploaded data file. The input data may be detected and/or collected using one or more sensor components of computing device(s) 102. Examples of sensors include microphones, touch-based sensors, geolocation sensors, accelerometers, optical/magnetic sensors, gyroscopes, keyboards, and pointing/selection tools.

Computing device(s) 102 may be further configured to process video data. In some implementations, computing device(s) 102 process video data into video segments or sliding windows of video content that comprise video data. The video data may also comprise audio data. In some implementations, computing device(s) 102 analyze the video data and the audio data to identify a set of video features and a set of audio features, respectively. Computing device(s) 102 then provide the set of audio features and the set of video features to a classifier. The classifier may be within computing device(s) 102 and is configured to detect a genre for the video content using the set of audio features and the set of video features. In some implementations, an indexer within computing device(s) 102 is configured to index the video content based on the genre. In some examples, computing device(s) 102 display the detected genre or index of genres using an interface, such as a graphical user interface (GUI), of computing device(s) 102. In some examples, computing device(s) 102 provide the detected genre to one or more other locations, such as service environment 106, via network 104.

Service environment 106 is configured to provide computing device(s) 102 access to various computing services and resources (e.g., applications, devices, storage, processing power, networking, analytics, intelligence). Service environment 106 may be implemented in a cloud-based or server-based environment using one or more computing devices, such as server devices (e.g., web servers, file servers, application servers, database servers), PCs, virtual devices, and mobile devices. These computing devices may comprise one or more sensor components, as discussed with respect to computing device(s) 102. Service environment 106 may comprise numerous hardware and/or software components and may be subject to one or more distributed computing models or services (e.g., Infrastructure as a Service (IaaS), Platform as a Service (PaaS), Software as a Service (SaaS), Functions as a Service (FaaS)). In some examples, service environment 106 provides input data to computing device(s) 102 and/or stores video data, audio data, and data resulting from analysis or processing received from computing device(s) 102. In at least one example, computing device(s) 102 use service environment 106 to process, at least in part, the input data.

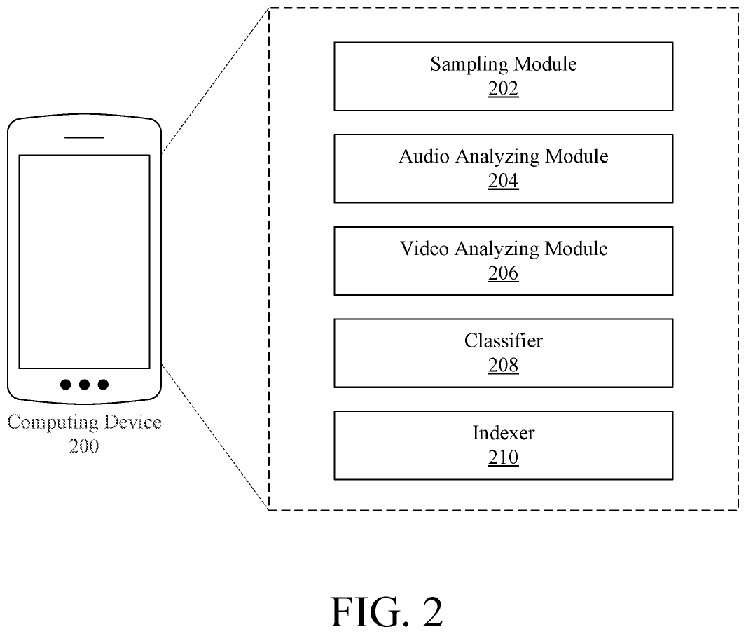

Referring to FIG. 2, a computing device 200 including modules is illustrated. In some implementations, video content is uploaded to a web-based platform, such as a social media platform, or downloaded to a computing device as described herein. A sampling module 202 is configured to sample a plurality of sliding windows of the video content. Sampling in this context refers to a method of reducing a continuous-time signal to a discrete-time signal by acquiring values of a signal at a constant or variable rate in order to process the video content. A sample therefore comprises a value of the signal at a point in time or space of the video content. Any suitable sampling technique can be used to sample the plurality of sliding windows such as, for example, taking samples of a certain data size, at a defined time interval, of a pixel frequency, or the like. The plurality of sliding windows that are sampled comprise audio data and video data. In examples, video data, as used herein, is comprised of a series of images captured by a camera, where each image is a frame. A shot includes one or more keyframes captured between an uninterrupted period of time from when the camera starts recording to when it stops recording (e.g., a single take). A keyframe comprises multiple frames. Audio data, as used herein, refers to data describing the amplitude over time of a sound wave representing an audio signal. In examples, the data is voltages of an audio signal and is represented as values between +1.0 and −1.0. In at least one example, each discrete data point (value) within the data is referred to as a sample

In implementations, an audio analyzing module 204 is configured to analyze the audio data to identify a set of audio features. The audio data comprises an audio signal. The audio signal is analyzed using various techniques including, for example, extracting phonemes and analyzing phonetic concepts, converting the audio data into a spectrogram and analyzing the image information, isolating one or more portions of the audio signal using segmentation, analysis using voice recognition, speech-to-text (STT), and the like. The analysis of the audio data thereby results in the set of audio features being identified. Examples of audio features include wave amplitude, harmonicity, pitch, tone, volume, bandwidth, words and phrases, and other features related to classifying the video content.

In implementations, a video analyzing module 206 is configured to analyze the video data to identify a set of video features. The video data is analyzed using various techniques including, for example, convolutional neural networks (CNN), scale-invariant feature transform (SIFT) analysis, silhouette analysis, object recognition, facial recognition, digital video fingerprinting, shot transition detection, image processing, and the like. The video data may also be analyzed using various algorithms including, for example, the Marr-Hildreth algorithm, a Canny edge detector algorithm, a Hough transform algorithm, a speeded up robust features (SURF) algorithm, and the like. The analysis of the video data thereby results in the set of video features being identified. In examples, the set of video features includes detected structures in the video data, such as points, corners, edges and objects, motion in sequences of images, shapes defined by boundaries between image regions, and other features relevant to classifying the video content.

In implementations, a classifier 208 is configured to receive the set of audio features and the set of video features and to detect a genre for the video content using the set of audio features and the set of video features. A classifier, as used herein, refers to a type of machine learning (ML) algorithm used to assign a class label to a data input. In some implementations, the classifier 208 is configured to calculate a probability factor using the set of audio features and the set of video features. The probability factor represents a likelihood that any given video content is of a certain genre. In examples, if the majority of the video features and the audio features are normally indicative of a certain genre, the detected genre for that video content will be determined by the classifier 208 using the probability factor. In some examples, the probability factor may be a numerical value that is calculated using a probability model that associates video features and audio features with a certain genre. In various implementations, the probability model is implemented by the classifier 208.

In implementations, an indexer 210 is configured to index the video content based on the genre. The indexer 210 may be implemented as an application programming interface (API), a Software as a Service (SaaS), or the like. The indexer 210 indexes the video content to make the video content searchable to a user via a search utility. Various pieces of information about video content may be used to index the video content, including keywords within the video content and metadata, such as author, creation date, duration, title of the video content, and the like. As one example, the indexer 210 inserts keywords into the video content to represent the topics explicitly or implicitly described by the video content, where the topics indicate or are related to a genre. A set of AI models for evaluating various different types of genres and topics is accessed. A subset of AI models that are configured to evaluate the topics described by the video content are selected from a set of AI models. The AI models in the set of AI models that are not configured to evaluate the topics described by the video content are not selected. The selected subset of AI models is then used to evaluate the video content. Accordingly, indexing the video file based on the genre prevents irrelevant AI models from being used to evaluate the video content, which reduces the computational costs of processing the video content. For example, after a genre for video content is detected, a video analysis pipeline, specific to that genre, and with only a subset of AI models, will be applied to enrich the video content. Insights that may be gathered by the subset of AI models include sentiments, keywords, tags, topics, person labeling, object labeling, particular events, and the like.

Having described one or more systems that may be employed by the aspects disclosed herein, this disclosure will now describe a method that may be performed by the various aspects. In implementations, method 300 is executed by a system, such as system 100 of FIG. 1. In other implementations, method 300 is performed by a single device, such as computing device 200, or by a single component that integrates the functionality of the components of computing device 200. In at least one implementation, method 300 is performed by one or more components of a distributed network, such as a web service or a cloud service.

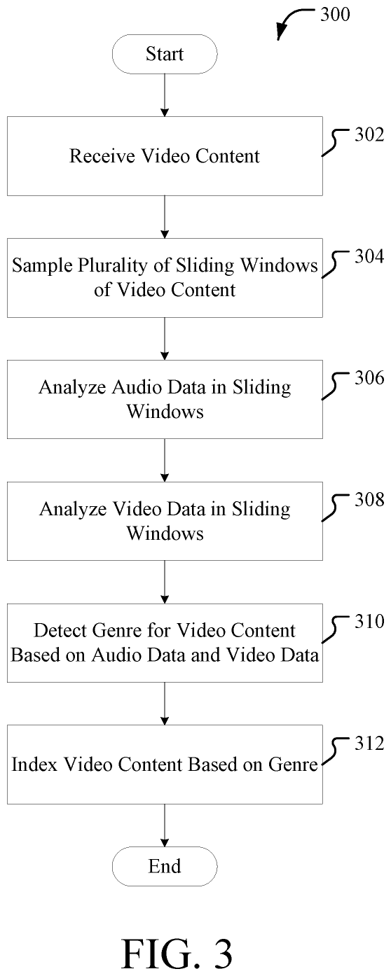

Referring to FIG. 3, an example method for video genre classification is illustrated. Example method 300 begins at operation 302, where video content is received. In examples, a computing device, such as computing device 200, receives the video content from a data source, such as a user (e.g., via a microphone or camera of the computing device) or another computing device. The video content may comprise video data in addition to audio data, image data, textual data, or the like. As a specific example, the content may be a video file comprising video data and audio data. Alternatively, the video content may be streaming data comprising an audio data stream and a video data stream.

At operation 304, a plurality of sliding windows is sampled. In examples, a data sampling component, such as the sampling module 202, samples the plurality of sliding windows. The data sampling component may sample the plurality of sliding windows by taking samples of a certain data size, at a defined time interval, of a pixel frequency, or the like. As one example, the plurality of sliding windows may be sampled at a data size defined by a stride length defining a number of samples between data windows (e.g., 250 samples) and a data window size defining the number of samples within the data window (e.g., 50 samples). As another example, the plurality of sliding windows may be sampled at time interval defined by a stride length defining a duration of time between data windows (e.g., 2 seconds) and a data window size defining the duration of time of the data window (e.g., 0.5 seconds).

At operation 306, the audio data is analyzed to identify a set of audio features. In examples, an audio analysis component, such as audio analyzing module 204, receives or is provided access to the audio data. The audio analysis component analyzes the audio data using techniques such as extracting phonemes and analyzing phonetic concepts, converting the audio data into a spectrogram and analyzing the image information, isolating one or more portions of the audio signal using segmentation, analysis using voice recognition, speech-to-text (STT), and the like. The analysis of the audio data thereby results in the set of audio features being identified. Examples of audio features include wave amplitude, harmonicity, pitch, tone, volume, bandwidth, words and phrases, and other features related to classifying the video content.

At operation 308, the video data is analyzed to identify a set of video features. In examples, a video analysis component, such as video analyzing module 206, receives or is provided access to the video data. The video analysis component analyzes the video data using techniques including convolutional neural networks (CNN), scale-invariant feature transform (SIFT) analysis, silhouette analysis, object recognition, facial recognition, digital video fingerprinting, shot transition detection, image processing, and the like. The video data may also be analyzed using various algorithms including, for example, the Marr-Hildreth algorithm, a Canny edge detector algorithm, a Hough transform algorithm, a speeded up robust features (SURF) algorithm, and the like. The analysis of the video data thereby results in the set of video features being identified. Examples of video features include detected structures in the video data, such as points, corners, edges and objects, motion in sequences of images, shapes defined by boundaries between image regions, and other features relevant to classifying the video content.

At operation 310, the genre for the video content is detected using the set of audio features and the set of video features. In examples, a classifier component, such as classifier 208, receives or is provided access to the set of audio features and the set of video features. The classifier component uses the set of audio features and the set of video features to calculate a probability factor representing a likelihood that any the video content is of a certain genre. For example, each genre may be associated with a predetermined set of audio features and video features. For instance, a “Sports” genre may be associated with video features such as images of various types of balls, jerseys, fields, event spectators, and the like. The “Sports” genre may be associated with audio features such player chatter, spectator cheering, music, and the like. The classifier component may compare the number and type of audio features and video features of the video content with the number and type of audio features and video features for each genre. Based on a number of matches or similarities between the audio features and video features of the video content and the potential genres, a genre may be selected. For instance, the genre having the most matches between the audio features and video features of the video content and the genre may be selected. Alternatively, multiple genres having matches between the audio features and video features of the video content and the genre may be selected (e.g., a top ‘N’ of the genres). In at least one example, a threshold number of audio features and video features must be matched between the video content and a genre in order for a genre to qualify for selection.

At operation 312, the video content is indexed based on the genre. In examples, an indexing component, such as indexer 210, receives or is provided access to one or more detected genres. The indexing component uses the detected genre(s) to apply keywords and/or metadata associated with the genre to the video content. For example, for video content for which a “Sports” genre has been detected, the indexing component may include keywords and/or metadata tags including or related to “Sports.” For instance, the specific sport, team, and location shown in the video content may be included as keywords in the video content. In at least one example, video content may relate to more than one genre. For instance, the video content may be associated with the “Sports” genre and the “Music” genre. In such an example, the indexing component may index the video content according to each genre detected. For instance, a first portion of the video content may be indexed according to the “Sports” genre and a second portion of the video content may be indexed according to the “Music” genre.

In examples, the computing device receiving the video content comprises or has access to a set of AI models for processing video content. The computing device selects a subset of AI models that are applicable to the indexed video content from the set of AI models based on the genre(s) of the video content. An AI model is determined to the applicable to the indexed video content if the AI model is configured to evaluate the genre with which the video content has been indexed. As a specific example, when video content is indexed with a “Sports” genre, AI models configured to provide insights for sports content are selected from the set of AI models. In such an example, AI models that are not configured to provide insights for sports content are not selected from the set of AI models.

In some examples, the detected genre for the video content is used to configure the subset of AI models for processing the video content. The detected genre may be used to set parameters or enable/disable functionality of the subset of AI models. As a specific example, when video content is indexed with a “Educational Lecture” genre, a “maximum number of speakers” parameter of a diarization model may be set to one to indicate to the diarization model that only the speech of the primary speaker is to be evaluated. Setting the parameter to one may disable unneeded functionality, such as pitch and tone analysis (as there is no need to distinguish between multiple speaker voices). In contrast, when video content is indexed with a “Talk Show” genre, a “maximum number of speakers” parameter of the diarization model may be set to a higher number (e.g., ten) to indicate to the diarization model that speech of every speaker (or the top ten most verbose speakers) is to be evaluated.

The subset of AI models that are applicable to the indexed video content is then used to evaluate the video content. Each AI model in the subset of AI models may generate a set of insights for the video content. The set(s) of insights may be presented to a user via a user interface of the computing device. In one example, the insights generated by the subset of AI models are provided to the user in a GUI as the video content is being received or played back. For instance, during the playback of an indexed video file using a media playback application, keywords identified in the video file are presented in a GUI of the media playback application.

Accordingly, the example method for video genre classification described in method 300 provides several improvements over previous video genre classification methods. As one example, evaluating video content using a subset of available AI models decreases the operational compute resources associated with video recognition and understanding by reducing the number of AI models used to evaluate the video content. Further, as each model of the subset of AI models is configured to evaluate the video content and may be further configured based on a detected genre, the insights provided by the subset of AI models are particularly relevant to the video content. Thus, the subset of AI models enables the video content analysis system to provide more precise insights while reducing the number less relevant insights, thereby significantly enhancing the user experience.

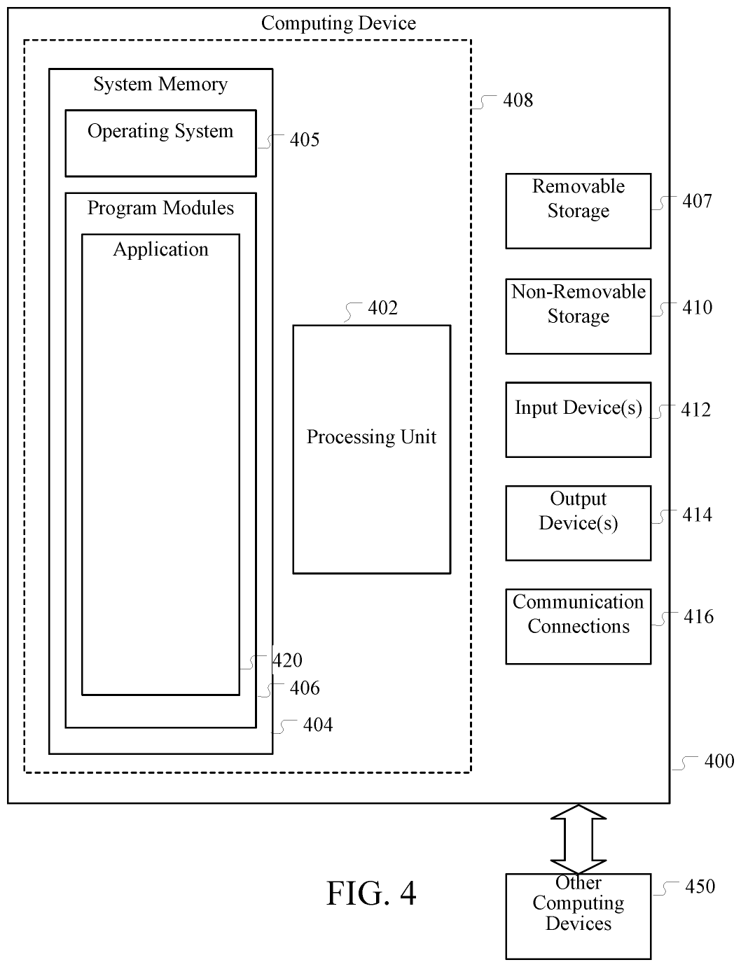

FIGS. 4-7 and the associated descriptions provide a discussion of a variety of operating environments in which aspects of the disclosure may be practiced. However, the devices and systems illustrated and discussed with respect to FIGS. 4-7 are for purposes of example and illustration, and, as is understood, a vast number of computing device configurations may be utilized for practicing aspects of the disclosure, described herein.

FIG. 4 is a block diagram illustrating physical components (e.g., hardware) of a computing device 400 with which aspects of the disclosure may be practiced. The computing device components described below may be suitable for the computing devices and systems described above. In a basic configuration, the computing device 400 includes a processing system 402 comprising at least one processing unit and a system memory 404. Depending on the configuration and type of computing device, the system memory 404 may comprise volatile storage (e.g., random access memory), non-volatile storage (e.g., read-only memory), flash memory, or any combination of such memories.

The system memory 404 includes an operating system 405 and one or more program modules 406 suitable for running software application 420, such as one or more components supported by the systems described herein. The operating system 405, for example, may be suitable for controlling the operation of the computing device 400.

Furthermore, embodiments of the disclosure may be practiced in conjunction with a graphics library, other operating systems, or any other application program and is not limited to any particular application or system. This basic configuration is illustrated in FIG. 4 by those components within a dashed line 408. The computing device 400 may have additional features or functionality. For example, the computing device 400 may also include additional data storage devices (removable and/or non-removable) such as, for example, magnetic disks, optical disks, or tape. Such additional storage is illustrated in FIG. 4 by a removable storage device 407 and a non-removable storage device 410.

As stated above, a number of program modules and data files may be stored in the system memory 404. While executing on the processing system 402, the program modules 406 (e.g., application 420) may perform processes including the aspects, as described herein. Other program modules that may be used in accordance with aspects of the present disclosure may include electronic mail and contacts applications, word processing applications, spreadsheet applications, database applications, slide presentation applications, drawing or computer-aided application programs, etc.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. For example, embodiments of the disclosure may be practiced via a system-on-a-chip (SOC) where each or many of the components illustrated in FIG. 4 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 400 on the single integrated circuit (chip). Embodiments of the disclosure may also be practiced using other technologies capable of performing logical operations such as, for example, AND, OR, and NOT, including mechanical, optical, fluidic, and quantum technologies. In addition, embodiments of the disclosure may be practiced within a general-purpose computer or in any other circuits or systems.

The computing device 400 may also have one or more input device(s) 412 such as a keyboard, a mouse, a pen, a sound or voice input device, a touch or swipe input device, etc. The output device(s) 414 such as a display, speakers, a printer, etc. may also be included. The aforementioned devices are examples and others may be used. The computing device 400 may include one or more communication connections 416 allowing communications with other computing devices 450. Examples of suitable communication connections 416 include radio frequency (RF) transmitter, receiver, and/or transceiver circuitry; universal serial bus (USB), parallel, and/or serial ports.

The term computer readable media as used herein includes computer storage media. Computer storage media includes volatile and nonvolatile, removable and non-removable media implemented in any method or technology for storage of information, such as computer readable instructions, data structures, or program modules. The system memory 404, the removable storage device 407, and the non-removable storage device 410 are all computer storage media examples (e.g., memory storage). Computer storage media includes random access memory (RAM), read-only memory (ROM), electrically erasable ROM (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 400. Any such computer storage media may be part of the computing device 400. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, communication media may include wired media such as a wired network or direct-wired connection, and wireless media such as acoustic, RF, infrared, and other wireless media.

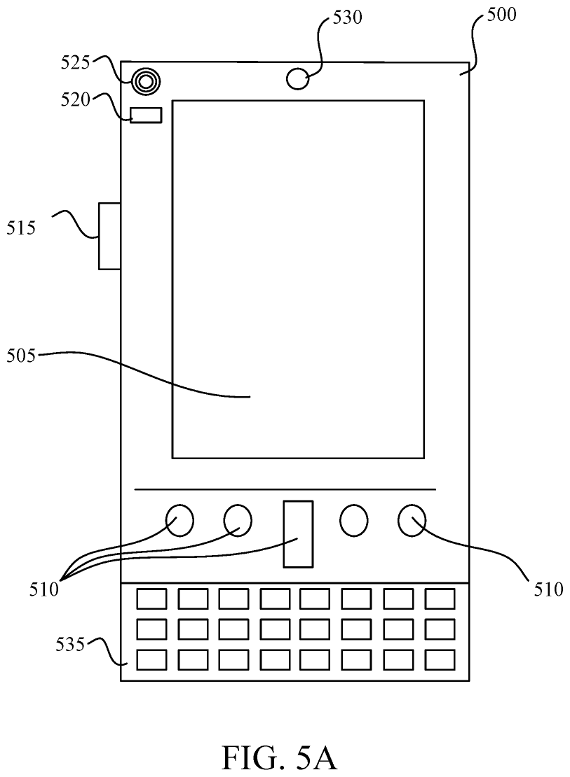

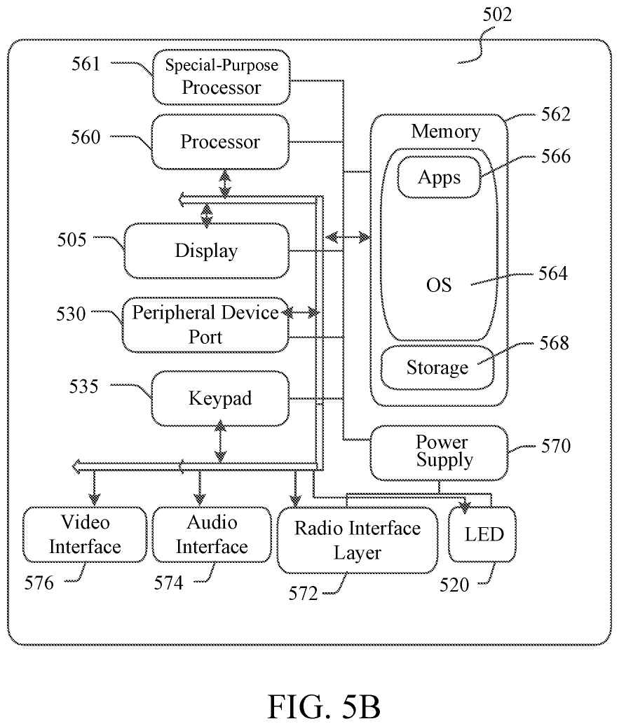

FIGS. 5A and 5B illustrate a mobile computing device 500, for example, a mobile telephone, a smart phone, wearable computer (such as a smart watch), a tablet computer, a laptop computer, and the like, with which embodiments of the disclosure may be practiced. In some aspects, the client may be a mobile computing device. With reference to FIG. 5A, one aspect of a mobile computing device 500 for implementing the aspects is illustrated. In a basic configuration, the mobile computing device 500 is a handheld computer having both input elements and output elements. The mobile computing device 500 typically includes a display 505 and one or more input buttons 510 that allow the user to enter information into the mobile computing device 500. The display 505 of the mobile computing device 500 may also function as an input device (e.g., a touch screen display).

If included, an optional side input element 515 allows further user input. The side input element 515 may be a rotary switch, a button, or any other type of manual input element. In alternative aspects, mobile computing device 500 may incorporate more or less input elements. For example, the display 505 may not be a touch screen in some embodiments.

In yet another alternative embodiment, the mobile computing device 500 is a portable phone system, such as a cellular phone. The mobile computing device 500 may also include an optional keypad 535. Optional keypad 535 may be a physical keypad or a “soft” keypad generated on the touch screen display.

In various embodiments, the output elements include the display 505 for showing a graphical user interface (GUI), a visual indicator 520 (e.g., a light emitting diode), and/or an audio transducer 525 (e.g., a speaker). In some aspects, the mobile computing device 500 incorporates a vibration transducer for providing the user with tactile feedback. In yet another aspect, the mobile computing device 500 incorporates input and/or output ports, such as an audio input (e.g., a microphone jack), an audio output (e.g., a headphone jack), and a video output (e.g., a HDMI port) for sending signals to or receiving signals from an external device.

FIG. 5B is a block diagram illustrating the architecture of one aspect of a mobile computing device. That is, the mobile computing device 500 can incorporate a system (e.g., an architecture) 502 to implement some aspects. In one embodiment, the system 502 is implemented as a “smart phone” capable of running one or more applications (e.g., browser, e-mail, calendaring, contact managers, messaging clients, games, and media clients/players). In some aspects, the system 502 is integrated as a computing device, such as an integrated personal digital assistant (PDA) and wireless phone.

One or more application programs 566 may be loaded into the memory 562 and run on or in association with the operating system 564. Examples of the application programs include phone dialer programs, e-mail programs, personal information management (PIM) programs, word processing programs, spreadsheet programs, Internet browser programs, messaging programs, and so forth. The system 502 also includes a non-volatile storage area 568 within the memory 562. The non-volatile storage area 568 may be used to store persistent information that should not be lost if the system 502 is powered down. The application programs 566 may use and store information in the non-volatile storage area 568, such as e-mail or other messages used by an e-mail application, and the like. A synchronization application (not shown) also resides on the system 502 and is programmed to interact with a corresponding synchronization application resident on a host computer to keep the information stored in the non-volatile storage area 568 synchronized with corresponding information stored at the host computer. As should be appreciated, other applications may be loaded into the memory 562 and run on the mobile computing device 500 described herein (e.g., search engine, sampling module, audio analyzing module, video analyzing module, classifier, and indexer).

The system 502 has a power supply 570, which may be implemented as one or more batteries. The power supply 570 might further include an external power source, such as an AC adapter or a powered docking cradle that supplements or recharges the batteries.

The system 502 may also include a radio interface layer 572 that performs the function of transmitting and receiving radio frequency communications. The radio interface layer 572 facilitates wireless connectivity between the system 502 and the “outside world,” via a communications carrier or service provider. Transmissions to and from the radio interface layer 572 are conducted under control of the operating system 564. In other words, communications received by the radio interface layer 572 may be disseminated to the application programs 566 via the operating system 564, and vice versa.

The visual indicator (e.g., light emitting diode (LED) 520) may be used to provide visual notifications, and/or an audio interface 574 may be used for producing audible notifications via the audio transducer 525. In the illustrated embodiment, the visual indicator 520 is a light emitting diode (LED) and the audio transducer 525 is a speaker. These devices may be directly coupled to the power supply 570 so that when activated, they remain on for a duration dictated by the notification mechanism even though the processor(s) (e.g., processor 560 and/or special-purpose processor 561) and other components might shut down for conserving battery power. The LED may be programmed to remain on indefinitely until the user takes action to indicate the powered-on status of the device. The audio interface 574 is used to provide audible signals to and receive audible signals from the user. For example, in addition to being coupled to the audio transducer 525, the audio interface 574 may also be coupled to a microphone to receive audible input, such as to facilitate a telephone conversation. In accordance with embodiments of the present disclosure, the microphone may also serve as an audio sensor to facilitate control of notifications, as will be described below. The system 502 may further include a video interface 576 that enables an operation of a peripheral device port 530 (e.g., an on-board camera) to record still images, video stream, and the like.

A mobile computing device 500 implementing the system 502 may have additional features or functionality. For example, the mobile computing device 500 may also include additional data storage devices (removable and/or non-removable) such as, magnetic disks, optical disks, or tape. Such additional storage is illustrated in FIG. 5B by the non-volatile storage area 568.

Data/information generated or captured by the mobile computing device 500 and stored via the system 502 may be stored locally on the mobile computing device 500, as described above, or the data may be stored on any number of storage media that may be accessed by the device via the radio interface layer 572 or via a wired connection between the mobile computing device 500 and a separate computing device associated with the mobile computing device 500, for example, a server computer in a distributed computing network, such as the Internet. As should be appreciated such data/information may be accessed via the mobile computing device 500 via the radio interface layer 572 or via a distributed computing network. Similarly, such data/information may be readily transferred between computing devices for storage and use according to well-known data/information transfer and storage means, including electronic mail and collaborative data/information sharing systems.

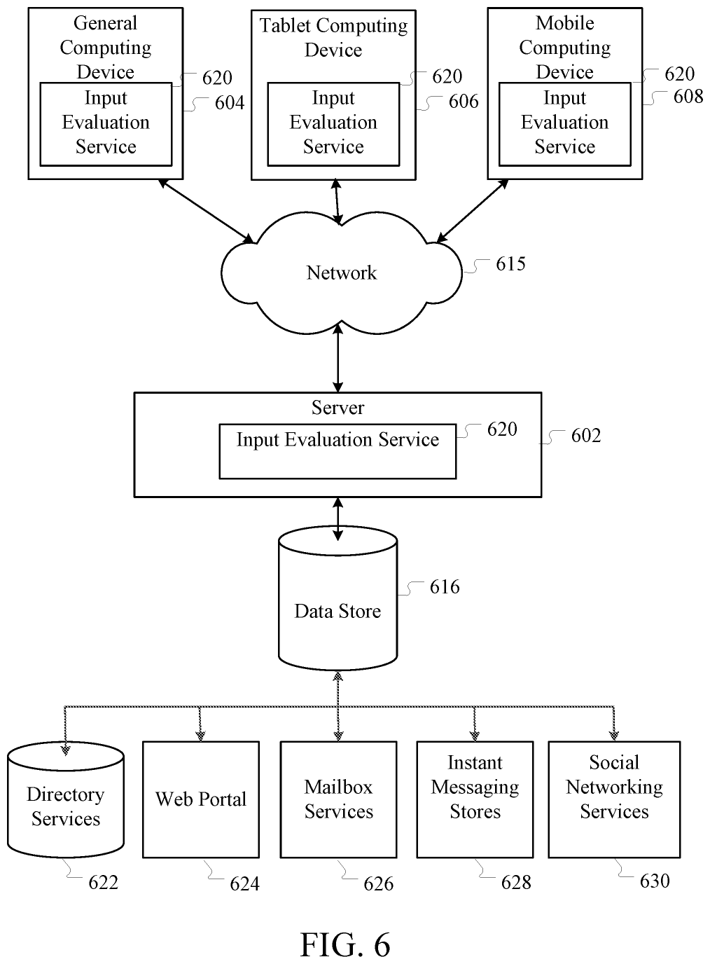

FIG. 6 illustrates one aspect of the architecture of a system for processing data received at a computing system from a remote source, such as a personal computer 604, tablet computing device 606, or mobile computing device 608, as described above. Content displayed at server device 602 may be stored in different communication channels or other storage types. For example, various documents may be stored using a directory service 622, a web portal 624, a mailbox service 626, an instant messaging store 628, or a social networking site 630.

An input evaluation service 620 may be employed by a client that communicates with server device 602, and/or input evaluation service 620 may be employed by server device 602. The server device 602 may provide data to and from a client computing device such as a personal computer 604, a tablet computing device 606 and/or a mobile computing device 608 (e.g., a smart phone) through a network 615. By way of example, the computer system described above may be embodied in a personal computer 604, a tablet computing device 606 and/or a mobile computing device 608 (e.g., a smart phone). Any of these embodiments of the computing devices may obtain content from the store 616, in addition to receiving graphical data useable to be either pre-processed at a graphic-originating system, or post-processed at a receiving computing system.

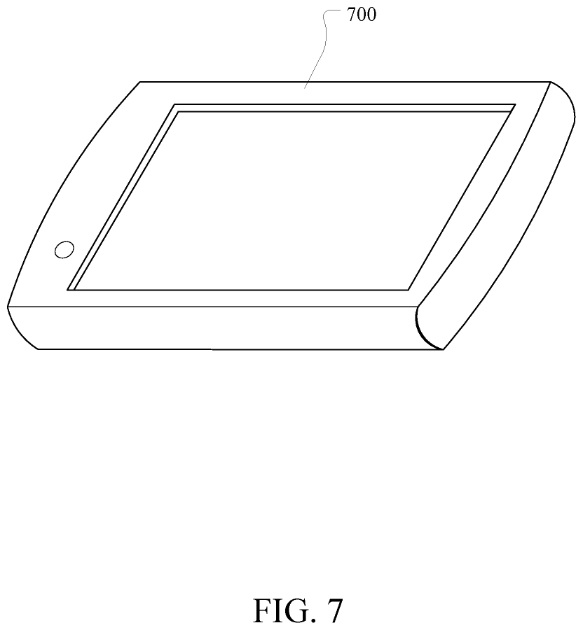

FIG. 7 illustrates an example of a tablet computing device 700 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which embodiments of the disclosure may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As will be understood from the foregoing disclosure, one example of the technology relates to a computer-implemented method. The method comprises: receiving video content; sampling a plurality of sliding windows of the video content, the plurality of sliding windows comprising video data; identifying a set of video features by analyzing the video data; detecting a genre for the video content using the set of video features; and indexing the video content based on the genre.

In another example, the technology relates to a system comprising: a processing system; and a memory coupled to the processing system, the memory comprising computer executable instructions that, when executed by the processing system, perform operations comprising: receiving video content; sampling a plurality of sliding windows of the video content, the plurality of sliding windows comprising audio data and video data; identifying a set of audio features by analyzing the audio data; identifying a set of video features by analyzing the video data; detecting a genre for the video content using the set of audio features and the set of video features; and indexing the video content based on the genre.

In another example, the technology relates to a system comprising: a sampling module stored in memory and configured to sample a plurality of sliding windows of video content, the plurality of sliding windows comprising audio data and video data; an audio analyzing module stored in memory and configured to analyze the audio data to identify a set of audio features; a video analyzing module stored in memory and configured to analyze the video data to identify a set of video features; a classifier stored in memory and configured to detect a genre for the video content using the set of audio features and the set of video features; and an indexer stored in memory and configured to index the video content based on the genre.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

What is claimed is:

1. A method comprising:
receiving video content;
sampling a plurality of sliding windows of the video content, the plurality of sliding windows comprising video data;
identifying a set of video features by analyzing the video data;
detecting a genre for the video content using the set of video features; and
indexing the video content based on the genre.

2. The method of claim 1, wherein the video content is received via an upload to a web-based platform.

3. The method of claim 1, wherein each sliding window of the plurality of sliding windows has a predetermined size.

4. The method of claim 1, wherein the video content further comprises audio data, wherein the method further comprises identifying a set of audio features by analyzing the audio data, and wherein detecting the genre uses the set of audio features.

5. The method of claim 4, wherein the set of audio features comprises a number of speakers in the video content.

6. The method of claim 1, further comprising calculating a probability factor using the set of video features, wherein detecting the genre further comprises using the probability factor.

7. The method of claim 1, further comprising applying a pipeline of video analysis models based on the genre.

8. A system comprising:
a processing system; and
a memory coupled to the processing system, the memory comprising computer executable instructions that, when executed by the processing system, perform operations comprising:
receiving video content;
sampling a plurality of sliding windows of the video content, the plurality of sliding windows comprising audio data and video data;
identifying a set of audio features by analyzing the audio data;
identifying a set of video features by analyzing the video data;
detecting a genre for the video content using the set of audio features and the set of video features; and
indexing the video content based on the genre.

9. The system of claim 8, wherein the video content is received via an upload to a web-based platform.

10. The system of claim 8, wherein each sliding window of the plurality of sliding windows has a predetermined size.

11. The system of claim 8, wherein the audio data and video data are comprised in keyframes of the video content.

12. The system of claim 8, wherein the set of audio features comprises a number of speakers in the video content.

13. The system of claim 8, further comprising calculating a probability factor using the set of audio features and the set of video features, wherein detecting the genre comprises using the probability factor.

14. The system of claim 8, further comprising selecting a pipeline of video analysis models based on the genre and applying the pipeline of video analysis models to the video content.

15. A system comprising:
a sampling module stored in memory and configured to sample a plurality of sliding windows of video content, the plurality of sliding windows comprising audio data and video data;
an audio analyzing module stored in memory and configured to analyze the audio data to identify a set of audio features;
a video analyzing module stored in memory and configured to analyze the video data to identify a set of video features;
a classifier stored in memory and configured to detect a genre for the video content using the set of audio features and the set of video features; and
an indexer stored in memory and configured to index the video content based on the genre.

16. The system of claim 15, wherein the video content is in a digital file uploaded to a web-based platform.

17. The system of claim 15, wherein each sliding window of the plurality of sliding windows has a predetermined size.

18. The system of claim 15, wherein the video content comprises keyframes that comprise the video data.

19. The system of claim 15, wherein the classifier is further configured to calculate a probability factor using the set of audio features and the set of video features, wherein the probability factor is used to detect the genre for the video content.

20. The system of claim 15, wherein a determined pipeline of video analysis models is applied to the video content based on the genre.
